(19) United States
(12) Patent Application Publication
(10) Pub. No.: US 2026/0356583 A1
(43) Pub. Date: Nov. 12, 2026

(54) DETACHABLE SENSOR JIG AND METHOD FOR PREDICTING VEHICLE MALFUNCTION

(71) Applicant: AutoStore Technology AS, Nedre Vats (NO)

(72) Inventors: Asheesh Saraswat, Heggedal (NO); Jørgen Djuve Heggebø, Langhus (NO)

(21) Appl. No.: 19/123,920

(22) PCT Filed: Oct. 23, 2023
(86) PCT No.: PCT/EP2023/079415

§ 371 Date: Apr. 24, 2025

(30) Foreign Application Priority Data
Oct. 26, 2022 (NO) 20221149

(51) Int. Cl. B65G 1/04; G01M 17/007; G07C 5/10

(52) U.S. Cl. CPC B65G 1/0464; G01M 17/007; G07C 5/10; B65G 2203/0275

(57) ABSTRACT

A sensor jig (600) for an automated vehicle (301) operating in an automated storage and retrieval system, in the form of a frame or box removably attachable to the vehicle. The frame or box having connection points (602) for the attachment of sensors (604) and/or one or more compartments (606) for the insertion of modules (608) containing sensors. The jig is mountable at a position on the vehicle that does not interfere with the normal operation of the vehicle in the automated storage and retrieval system. Data collected by the sensors is used in a method for predicting malfunctions, by comparing the collected data to baseline values and/or historical maintenance data.

### FIELD OF THE INVENTION

The present invention relates to an automated storage and retrieval system for storage and retrieval of containers, in particular to a detachable sensor jig arranged to collect data from an automated vehicle operating in an automated storage and retrieval system, the data being useful in a method for early detection of and/or predicting a potential malfunction of the vehicle.

### BACKGROUND AND PRIOR ART

FIG. 1 discloses a prior art automated storage and retrieval system 1 with a framework structure 100 and FIGS. 2, 3 and 4 disclose three different prior art container handling vehicles 201,301,401 suitable for operating on such a system 1. The framework structure 100 comprises upright members 102 and a storage volume comprising storage columns 105 arranged in rows between the upright members 102. In these storage columns 105 storage containers 106, also known as bins, are stacked one on top of one another to form stacks 107. The members 102 may typically be made of metal, e.g. extruded aluminum profiles.

The framework structure 100 of the automated storage and retrieval system 1 comprises a rail system 108 arranged across the top of framework structure 100, on which rail system 108 a plurality of container handling vehicles 201,301,401 may be operated to raise storage containers 106 from, and lower storage containers 106 into, the storage columns 105, and also to transport the storage containers 106 above the storage columns 105. The rail system 108 comprises a first set of parallel rails 110 arranged to guide movement of the container handling vehicles 201,301,401 in a first direction X across the top of the frame structure 100, and a second set of parallel rails 111 arranged perpendicular to the first set of rails 110 to guide movement of the container handling vehicles 201,301,401 in a second direction Y which is perpendicular to the first direction X. Containers 106 stored in the columns 105 are accessed by the container handling vehicles 201,301,401 through access openings 112 in the rail system 108. The container handling vehicles 201,301,401 can move laterally above the storage columns 105, i.e. in a plane which is parallel to the horizontal X-Y plane.

The upright members 102 of the framework structure 100 may be used to guide the storage containers during raising of the containers out from and lowering of the containers into the columns 105. The stacks 107 of containers 106 are typically self-supporting.

Each prior art container handling vehicle 201,301,401 comprises a vehicle body 201a, 301a, 401a and first and second sets of wheels 201b, 201c, 301b, 301c, 401b, 401c which enable the lateral movement of the container handling vehicles 201,301,401 in the X direction and in the Y direction, respectively. In FIGS. 2, 3 and 4 two wheels in each set are fully visible. The first set of wheels 201b, 301b, 401b is arranged to engage with two adjacent rails of the first set 110 of rails, and the second set of wheels 201c, 301c, 401c is arranged to engage with two adjacent rails of the second set 111 of rails. At least one of the sets of wheels 201b, 201c, 301b,301c, 401b, 401c can be lifted and lowered, so that the first set of wheels 201b, 301b, 401b and/or the second set of wheels 201c, 301c, 401c can be engaged with the respective set of rails 110, 111 at any one time.

Each prior art container handling vehicle 201,301,401 also comprises a lifting device for vertical transportation of storage containers 106, e.g. raising a storage container 106 from, and lowering a storage container 106 into, a storage column 105. The lifting device comprises one or more gripping/engaging devices which are adapted to engage a storage container 106, and which gripping/engaging devices can be lowered from the vehicle 201,301,401 so that the position of the gripping/engaging devices with respect to the vehicle 201,301,401 can be adjusted in a third direction Z which is orthogonal the first direction X and the second direction Y. Parts of the gripping device of the container handling vehicles 301,401 are shown in FIGS. 3 and 4 indicated with reference number 304,404. The gripping device of the container handling device 201 is located within the vehicle body 201a in FIG. 2 and is thus not shown.

Conventionally, and also for the purpose of this application, Z=1 identifies the uppermost layer available for storage containers below the rails 110, 111, i.e. the layer immediately below the rail system 108, Z=2 the second layer below the rail system 108, Z=3 the third layer etc. In the exemplary prior art disclosed in FIG. 1, Z=8 identifies the lowermost, bottom layer of storage containers. Similarly, X=1 . . . n and Y=1 . . . n identifies the position of each storage column 105 in the horizontal plane. Consequently, as an example, and using the Cartesian coordinate system X, Y, Z indicated in FIG. 1, the storage container identified as 106′ in FIG. 1 can be said to occupy storage position X=17, Y=1, Z=6. The container handling vehicles 201,301,401 can be said to travel in layer Z=0, and each storage column 105 can be identified by its X and Y coordinates. Thus, the storage containers shown in FIG. 1 extending above the rail system 108 are also said to be arranged in layer Z=0.

The storage volume of the framework structure 100 has often been referred to as a grid 104, where the possible storage positions within this grid are referred to as storage cells. Each storage column may be identified by a position in an X- and Y-direction, while each storage cell may be identified by a container number in the X-, Y- and Z-direction.

Each prior art container handling vehicle 201, 301, 401 comprises a storage compartment or space for receiving and stowing a storage container 106 when transporting the storage container 106 across the rail system 108. The storage space may comprise a cavity arranged internally within the vehicle body 201a,401a as shown in FIGS. 2 and 4 and as described in e.g. WO2015/193278A1 and WO2019/206487A1, the contents of which are incorporated herein by reference.

FIG. 3 shows an alternative configuration of a container handling vehicle 301 with a cantilever construction. Such a vehicle is described in detail in e.g. NO317366, the contents of which are also incorporated herein by reference.

The cavity container handling vehicle 201 shown in FIG. 2 may have a footprint that covers an area with dimensions in the X and Y directions which is generally equal to the lateral extent of a storage column 105, e.g. as is described in WO2015/193278A1, the contents of which are incorporated herein by reference.

The term ‘lateral’used herein may mean ‘horizontal’.

Alternatively, the cavity container handling vehicles 401 may have a footprint which is larger than the lateral area defined by a storage column 105 as shown in FIGS. 1 and 4, e.g. as is disclosed in WO2014/090684A1 or WO2019/206487A1.

The rail system 108 typically comprises rails with grooves in which the wheels of the vehicles run. Alternatively, the rails may comprise upwardly protruding elements, where the wheels of the vehicles comprise flanges to prevent derailing.

These grooves and upwardly protruding elements are collectively known as tracks. Each rail may comprise one track, or each rail 110, 111 may comprise two parallel tracks. In other rail systems 108, each rail in one direction (e.g. an X direction) may comprise one track and each rail in the other, perpendicular direction (e.g. a Y direction) may comprise two tracks. Each rail 110, 111 may also comprise two track members that are fastened together, each track member providing one of a pair of tracks provided by each rail.

WO2018/146304A1, the contents of which are incorporated herein by reference, illustrates a typical configuration of rail system 108 comprising rails and parallel tracks in both X and Y directions.

In the framework structure 100, a majority of the columns 105 are storage columns 105, i.e. columns 105 where storage containers 106 are stored in stacks 107.

However, some columns 105 may have other purposes. In FIG. 1, columns 119 and 120 are such special-purpose columns used by the container handling vehicles 201, 301, 401 to drop off and/or pick up storage containers 106 so that they can be transported to an access station (not shown) where the storage containers 106 can be accessed from outside of the framework structure 100 or transferred out of or into the framework structure 100. Within the art, such a location is normally referred to as a ‘port’ and the column in which the port is located may be referred to as a ‘port column’ 119, 120. The transportation to the access station may be in any direction, that is horizontal, tilted and/or vertical. For example, the storage containers 106 may be placed in a random or dedicated column 105 within the framework structure 100, then picked up by any container handling vehicle and transported to a port column 119, 120 for further transportation to an access station. The transportation from the port to the access station may require movement along various different directions, by means such as delivery vehicles, trolleys or other transportation lines. Note that the term ‘tilted’ means transportation of storage containers 106 having a general transportation orientation somewhere between horizontal and vertical.

In FIG. 1, the first port column 119 may for example be a dedicated drop-off port column where the container handling vehicles 201, 301, 401 can drop off storage containers 106 to be transported to an access or a transfer station, and the second port column 120 may be a dedicated pick-up port column where the container handling vehicles 201, 301, 401 can pick up storage containers 106 that have been transported from an access or a transfer station.

The access station may typically be a picking or a stocking station where product items are removed from or positioned into the storage containers 106. In a picking or a stocking station, the storage containers 106 are normally not removed from the automated storage and retrieval system 1, but are returned into the framework structure 100 again once accessed. A port can also be used for transferring storage containers to another storage facility (e.g. to another framework structure or to another automated storage and retrieval system), to a transport vehicle (e.g. a train or a lorry), or to a production facility.

A conveyor system comprising conveyors is normally employed to transport the storage containers between the port columns 119, 120 and the access station.

If the port columns 119, 120 and the access station are located at different levels, the conveyor system may comprise a lift device with a vertical component for transporting the storage containers 106 vertically between the port column 119, 120 and the access station.

The conveyor system may be arranged to transfer storage containers 106 between different framework structures, e.g. as is described in WO2014/075937A1, the contents of which are incorporated herein by reference.

When a storage container 106 stored in one of the columns 105 disclosed in FIG. 1 is to be accessed, one of the container handling vehicles 201, 301, 401 is instructed to retrieve the target storage container 106 from its position and transport it to the drop-off port column 119. This operation involves moving the container handling vehicle 201, 301, 401 to a location above the storage column 105 in which the target storage container 106 is positioned, retrieving the storage container 106 from the storage column 105 using the container handling vehicle's 201, 301, 401 lifting device (not shown), and transporting the storage container 106 to the drop-off port column 119. If the target storage container 106 is located deep within a stack 107, i.e. with one or a plurality of other storage containers 106 positioned above the target storage container 106, the operation also involves temporarily moving the above-positioned storage containers prior to lifting the target storage container 106 from the storage column 105. This step, which is sometimes referred to as “digging” within the art, may be performed with the same container handling vehicle that is subsequently used for transporting the target storage container to the drop-off port column 119, or with one or a plurality of other cooperating container handling vehicles. Alternatively, or in addition, the automated storage and retrieval system 1 may have container handling vehicles 201, 301, 401 specifically dedicated to the task of temporarily removing storage containers 106 from a storage column 105. Once the target storage container 106 has been removed from the storage column 105, the temporarily removed storage containers 106 can be repositioned into the original storage column 105. However, the removed storage containers 106 may alternatively be relocated to other storage columns 105.

When a storage container 106 is to be stored in one of the columns 105, one of the container handling vehicles 201, 301, 401 is instructed to pick up the storage container 106 from the pick-up port column 120 and transport it to a location above the storage column 105 where it is to be stored. After any storage containers 106 positioned at or above the target position within the stack 107 have been removed, the container handling vehicle 201, 301, 401 positions the storage container 106 at the desired position. The removed storage containers 106 may then be lowered back into the storage column 105, or relocated to other storage columns 105.

For monitoring and controlling the automated storage and retrieval system 1, e.g. monitoring and controlling the location of respective storage containers 106 within the framework structure 100, the content of each storage container 106, and the movement of the container handling vehicles 201, 301, 401 so that a desired storage container 106 can be delivered to the desired location at the desired time without the container handling vehicles 201, 301, 401 colliding with each other, the automated storage and retrieval system 1 comprises a control system 500 which typically is computerized and which typically comprises a database for keeping track of the storage containers 106.

### Prediction Of Vehicle Malfunction, Particularly

As can be appreciated, the automated vehicles operating in an automated storage and retrieval system are complex devices, susceptible of malfunction. Malfunctioning vehicles are one of the main causes of system downtime. Historical maintenance data and experimental data for such vehicles indicates that many types of malfunctions are preceded by observable events, such as observable anomalies and aberrations in various vehicle parameters, such as the development of excessive heat, particular noises or vibrations, degradation in vehicle acceleration or lifting capacity of the vehicle's lifting device, loss of efficiency in energy consumption, battery charge capacity and other observable parameters. It would therefore desirable to be able to predict or detect at an early stage a potential malfunction of a vehicle, so that corrective measures may be taken before a malfunction occurs.

### SUMMARY OF THE INVENTION

The present invention is set forth and characterized in the independent claims, while the dependent claims describe other characteristics of the invention.

In one aspect, the invention is related a jig that is detachably mounted to a vehicle operating in an automated storage and retrieval system, the jig being provided with one or more sensors and/or cameras for observing and/or recording various operational parameters of the vehicle. Examples of such sensors are cameras, microphones, infrared heat detectors, accelerometers, vibration sensors, voltmeters and other electronic testing apparatus, torque sensors, etc. Parameters measured by the sensors can include heat, noise, vibration, vehicle acceleration and deceleration, lifting capacity of the vehicle lifting mechanism, the efficiency of energy consumption of the vehicle, battery charge capacity and other observable parameters. The jig is preferably arranged such that the vehicle may continue to perform its intended tasks in the system with the jig attached, with the sensors collecting data from the vehicle while the vehicle performs actual tasks in real time. In one aspect, the jig is a metal frame or box with attachment points for sensors, removably mounted to the outside of the vehicle by means known in the art, at a position that does not obstruct the lifting mechanism of the vehicle. The sensors may be individual devices connected to attachments points, or may comprise one or more sensors within a removable module that may be inserted into a compartment in the jig. The sensors may be provided with their own power sources, or may be powered by a common power source on the jig, or alternatively by the vehicle battery, in which case the jig may comprise an electrical connection to the vehicle battery.

In a second aspect, the invention concerns a method for utilizing the data collected by the sensor jig in order to detect and/or predict a potential malfunction of the vehicle. In one aspect, the method comprises establishing a default baseline range of normal or acceptable values for various vehicle parameters. The values, which may be established in connection with the manufacture of the vehicle, may be for the vehicle as a whole, or may be more granular in nature, in that the values pertain to individual components of the vehicle. According to an aspect of the invention, the data collected by the sensor jig is compared to the default values in order to detect or predict a potential malfunction. According to one aspect, the data is compared with historical maintenance data and/or experimental data in order to arrive at the prediction of malfunction. Examples of such comparisons/conclusions may include:
historical maintenance data or experimental data may indicate that the failure of a particular component is preceded by discrete frequency tones in the audible or inaudible spectrum, for example a particular frequency may indicate a degree of wear on a particular motor component,
the a build up of heat at a particular location on the vehicle may be indicative of a defect of a particular component, for example heat measured at a location of the vehicle body adjacent to the battery compartment and falling outside the baseline temperature values for that specific location could indicate a problem with the battery,
if the vehicle were observed to run slower for a given power input than the baseline date would suggest, this could be indicative of a worn wheel bearing,
a particular vibration pattern or intensity may be indicative of a particular defect or malfunction, for example a deformation of a wheel or a loose bolt securing a particular component within the vehicle.

The preceding list is merely exemplary and is not exhaustive, as maintenance data and/or experimental data may continuously be developed showing correlations between observable aberrations and specific malfunctions.

In another aspect, the method comprises the use of an artificial intelligence (AI) program, artificial neural network or machine learning algorithm (hereafter referred to collectively or alternatively as an “AI”) to detect or predict a malfunction. According to this aspect, data is collected and communicated to the AI, which produces an output in the form of a prediction of a malfunction, or a health status of the vehicle.

In a third aspect, the invention concerns a method for training an AI to detect or predict the malfunction of vehicles operating in an automated storage and retrieval system. According to one aspect, the method comprises the input of baseline, default values for various vehicle parameters, the input of historical maintenance data and/or experimental data for an individual vehicle or a fleet of vehicles, and the input of sensor data accumulated from an individual vehicle. According to this aspect, the accuracy or inaccuracy of predictions generated by the AI are utilized by the AI to refine its predictive accuracy.

According to one aspect, the invention comprises a sensor jig for an automated vehicle operating in an automated storage and retrieval system, the jig comprising a frame or box removably attachable to the vehicle, the frame or box having connection points for the attachment of sensors and/or one or more compartments for the insertion of modules containing sensors, the jig being mountable at a position on the vehicle that does not interfere with the normal operation of the vehicle in the automated storage and retrieval system, and wherein the sensors are arranged to collect data regarding vehicle parameters while the vehicle is in normal operation in the storage and retrieval system.

According to another aspect, the invention comprises a method for detecting or predicting a malfunction in an automated vehicle operating in an automated storage and retrieval system, the method comprising the steps of:
a. establishing for a vehicle a baseline set of normal values for various vehicle parameters,
b. establishing historical maintenance data and/or experimental data for the vehicle, or for a fleet of vehicle of similar model and design, the historical maintenance data and/or experimental data comprising correlations between observable vehicle parameters and the occurrence of malfunctions of a vehicle,
c. attaching a sensor jig as described above to the vehicle,
d. using the sensors of the sensor jig to collect data regarding vehicle parameters while the vehicle is in normal operation in the automated storage and retrieval system,
e. comparing the data collected by the sensors with the baseline values and/or the historical maintenance and/or experimental data,
f. based on the comparison, making a prediction of a vehicle malfunction.

### BRIEF DESCRIPTION OF THE DRAWINGS

The following drawings are appended to facilitate the understanding of the invention. The drawings show embodiments of the invention, which will now be described by way of example only, where:

FIG. 1 is a perspective view of a framework structure of a prior art automated storage and retrieval system.

FIG. 2 is a perspective view of a prior art container handling vehicle having an internally arranged cavity for carrying storage containers therein.

FIG. 3 is a perspective view of a prior art container handling vehicle having a cantilever for carrying storage containers underneath.

FIG. 4 is a perspective view, seen from below, of a prior art container handling vehicle having an internally arranged cavity for carrying storage containers therein.

FIG. 5 is a perspective view of a container handling vehicle with a sensor jig mounted to the vehicle.

FIG. 6 is a side elevational view of the vehicle and jig fra FIG. 5.

FIG. 7 is a flowchart illustrating the steps of training an artificial intelligence program, artificial neural network or machine learning algorithm.

### DETAILED DESCRIPTION OF THE INVENTION

In the following, embodiments of the invention will be discussed in more detail with reference to the appended drawings. It should be understood, however, that the drawings are not intended to limit the invention to the subject-matter depicted in the drawings.

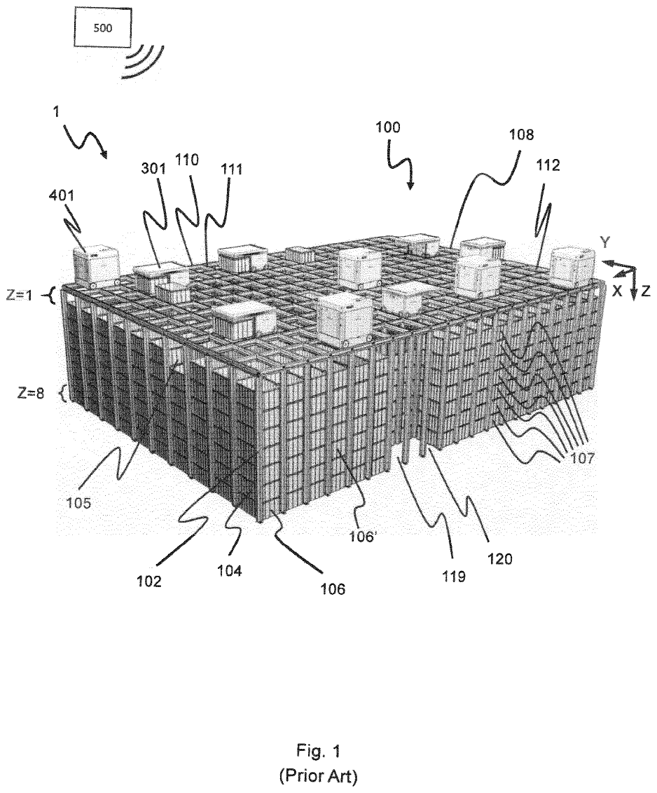

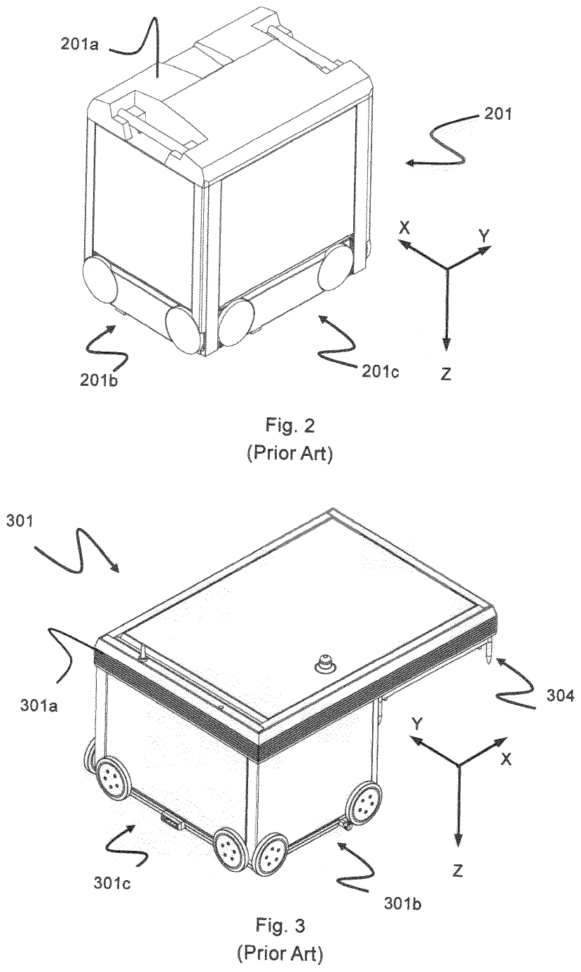

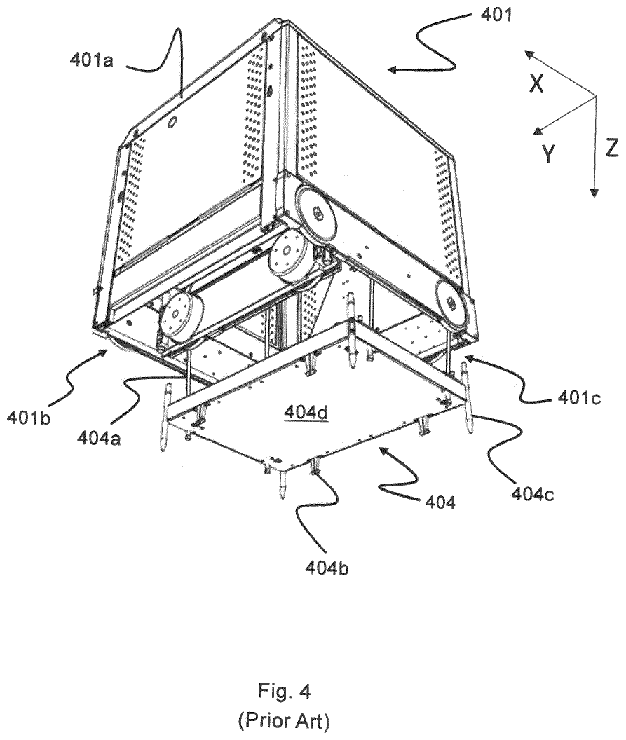

The framework structure 100 of the automated storage and retrieval system 1 is constructed in a similar manner to the prior art framework structure 100 described above in connection with FIGS. 1-4. That is, the framework structure 100 comprises a number of upright members 102, and comprises a first, upper rail system 108 extending in the X direction and Y direction.

The framework structure 100 further comprises storage compartments in the form of storage columns 105 provided between the members 102 wherein storage containers 106 are stackable in stacks 107 within the storage columns 105.

The framework structure 100 can be of any size. In particular it is understood that the framework structure can be considerably wider and/or longer and/or deeper than disclosed in FIG. 1. For example, the framework structure 100 may have a horizontal extent of more than 700×700 columns and a storage depth of more than twelve containers.

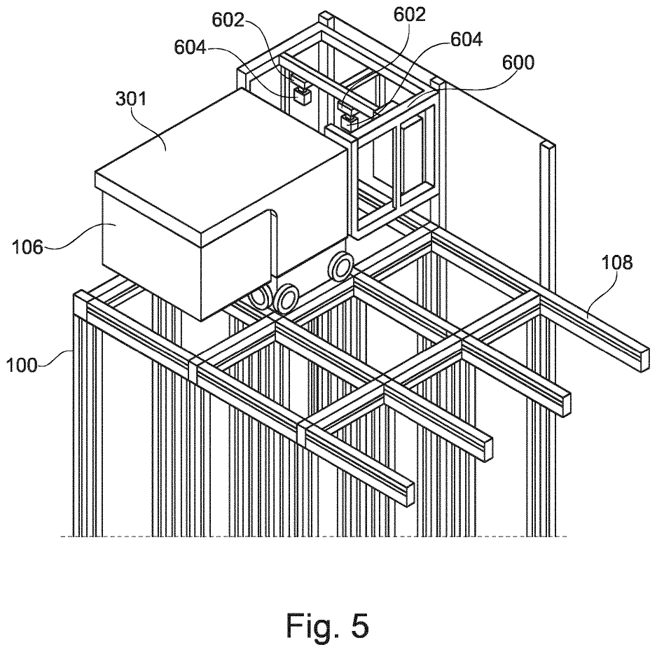

One embodiment of the automated storage and retrieval system according to the invention will now be discussed in more detail with reference to FIGS. 5, 6 and 7.

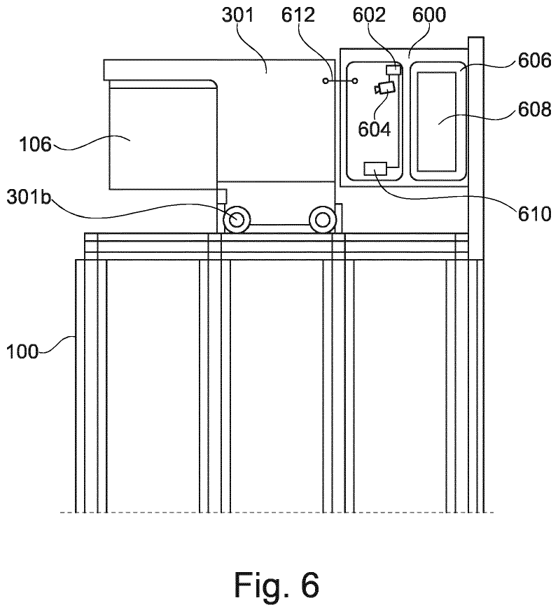

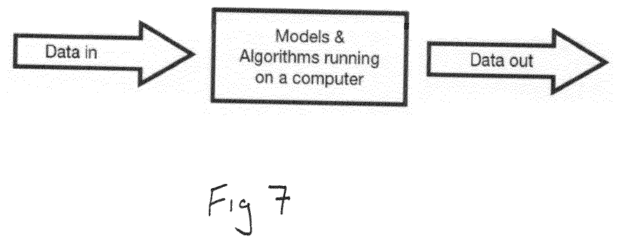

FIGS. 5 and 6 show a container handling vehicle 301 operating on rail system 108 of framework 100. It should be understood that the present invention also relates to container handling vehicle 401, or any automated vehicle operating in the system. Vehicle 301 is depicted carrying a container 106 in order to illustrate that vehicle 301 is capable of performing its ordinary tasks.

Attached to vehicle 301 is a sensor jig 600. Sensor jig 600, according to one aspect, is removably connected to the vehicle body by means known in the art.

According to one aspect, sensor jig 600 is in the form of a frame or box having one or more connection points 602 to which may be attached one or more sensors 604. As used herein, the term “sensor” is to be understood as any form of equipment designed for observing, recording and/or collecting data, such as for example cameras, microphones, infrared heat detectors, accelerometers, vibration sensors, voltmeters and other electric testing apparatus, torque sensors and the like. Alternatively, as shown in FIG. 6 the frame may be provided with one or more compartments 606 into which may be inserted a removable module 608 comprising one or more sensors, computer equipment and the like. The jig may comprise its own power source 610 for supplying electrical power to the sensors and/or modules, or the jig may be providing with an electrical connection 612 for connecting to the battery of the vehicle in order to supply power to the sensors and/or modules.

Sensors 604 are arranged to collected data from vehicle 301 while the vehicle operates in the automated storage and retrieval system. Accordingly, the jig is attached to the vehicle body at a position that does not interfere with the operation of the vehicle lifting mechanism, allowing the vehicle to lift and transport containers 106 while the jig is attached. Examples of data collected by the sensors include various vehicle parameter such as heat, noise, vibration, vehicle acceleration and deceleration, lifting capacity of the vehicle lifting mechanism, the efficiency of energy consumption of the vehicle, battery charge capacity and other observable parameters.

According to another aspect, the invention provides a method for detecting or predicting a vehicle malfunction, illustrated conceptually by FIG. 7. According to this method, vehicle data is introduced to a computer system comprising an artificial intelligence program, artificial neural network or machine learning algorithm (hereafter collectively or alternatively referred to as “the AI”). Based on the data input, the AI generates an output that may comprise a detection of, or a prediction of a vehicle malfunction. The AI may be run on control system 500, or in a separate, dedicated computer system.

According to this method, the data input to the AI may comprise a baseline, default range of values established for various vehicle parameters at the time of manufacture. Examples of such baseline values may include, but are not limited to:
normal, acceptable temperature ranges for the vehicle as a whole or for various components of the vehicle. Such temperature ranges may include temperature measured at a specific location on the vehicle body, for example at a wall in proximity to a motor or other component,
Sound profiles, comprising ranges of audible or inaudible frequencies produced by the vehicle during normal operation, for example a normal range of sound frequencies during a lifting operation, a change of direction of the vehicle, during recharging of the battery and the like.
A range of normal values for vibrations during operation of the vehicle and during the performance of various activities,
A range of torque values for a lifting operation,
Ranges of expected values for acceleration and deceleration of the vehicle with various loads

According to the method, the data input to the AI may comprise historical maintenance data and/or experimental data related to vehicle malfunctions. Such data may include for example the identification of specific parameters connected with, or shown to precede, a vehicle malfunction. Such historical and/or experimental data may include, but is not limited to:
sound frequencies connected with, or that precede a malfunction,
specific types or amounts of vibration associated with malfunctions, for example specific vibration patterns or intensities,
the temperature of various components or at specific locations on the vehicle body connected with or preceding a malfunction,
Battery degradation data,
Changes to vehicle acceleration and/or deceleration shown to be connected with, or to precede a malfunction.

According to the method, the data input to the AI may comprise previous data output from the AI itself, which is utilized by the AI to refine the predictive accuracy of future outputs.

According to another aspect, the invention provides a method of training an AI, comprising the step of inputting the data described above into the AI. According to this aspect, the vehicle for which a prediction is made is observed for a period of time or inspected, with the results of the observation or inspection being fed back into the AI, which the AI then utilizes in order to refine its predictive accuracy.

An example of the method would include:
Providing baseline values for various vehicle parameters, as described above
Inputting the base line data into the AI
Attaching the sensor jig described above to a vehicle
Collecting vehicle data as described above while the vehicle is in operation in the automated storage and retrieval system,
Inputting the collected data into the AI,
Inputting historical maintenance data and/or experimental data as described above into the AI,
Determining whether the data collected by the sensors falls outside of the baseline values,
Comparing the deviations from the baseline values with historical maintenance data and/or experimental data,
Based on the comparison, making a prediction regarding a potential malfunction

The method could include the further step of observing the vehicle for a period of time and/or inspecting the vehicle after a prediction has been made, determining whether the prediction of malfunction was accurate or not (or whether the vehicle parameters deviate further from the baseline values), and inputting the results of the observation and/or inspection into the AI in order to refine the predictive accuracy of the AI.

In the preceding description, various aspects of the delivery vehicle and the automated storage and retrieval system according to the invention have been described with reference to the illustrative embodiment. For purposes of explanation, specific numbers, systems and configurations were set forth in order to provide a thorough understanding of the system and its workings. However, this description is not intended to be construed in a limiting sense. Various modifications and variations of the illustrative embodiment, as well as other embodiments of the system, which are apparent to persons skilled in the art to which the disclosed subject matter pertains, are deemed to lie within the scope of the present invention.

LIST OF REFERENCE NUMBERS

### Prior Art (FIGS. 1-4):

1 Prior art automated storage and retrieval system
100 Framework structure
102 Upright members of framework structure
104 Storage grid
105 Storage column
106 Storage container
106′ Particular position of storage container
107 Stack
108 Rail system
110 Parallel rails in first direction (X)
112 Access opening
119 First port column
120 Second port column
201 Prior art container handling vehicle
201a Vehicle body of the container handling vehicle 201
201b Drive means/wheel arrangement/first set of wheels in first direction (X)
201c Drive means/wheel arrangement/second set of wheels in second direction (Y)
301 Prior art cantilever container handling vehicle
301a Vehicle body of the container handling vehicle 301
301b Drive means/first set of wheels in first direction (X)
301c Drive means/second set of wheels in second direction (Y)
304 Gripping device
401 Prior art container handling vehicle
401a Vehicle body of the container handling vehicle 401
401b Drive means/first set of wheels in first direction (X)
401c Drive means/second set of wheels in second direction (Y)
404 Gripping device
404a Lifting band
404b Gripper
404c Guide pin
404d Lifting frame
500 Control system
X First direction
Y Second direction
Z Third direction
600 Jig
602 Sensor attachment point
604 Sensor
606 Compartment
608 Module
610 Power supply
612 Electrical connection to vehicle

1-13. (canceled)

14. A sensor jig for an automated vehicle operating in an automated storage and retrieval system, the jig comprising a frame or box removably attachable to the vehicle, the frame or box having connection points the attachment of one or more sensors and/or one or more compartments for the insertion of modules containing sensors, the jig being mountable at a position on the vehicle that does not interfere with the normal operation of the vehicle in the automated storage and retrieval system, and wherein the sensors are arranged to collect data regarding vehicle parameters while the vehicle is in normal operation in the storage and retrieval system.

15. The sensor jig according to claim 14, wherein the jig comprises a common power source for supplying electric power to the sensors.

16. The sensor jig according to claim 14, wherein the jig comprises an electrical connection to a vehicle battery for supplying electrical power to the sensors.

17. The sensor jig according to claim 14, wherein the sensors are arranged to collect data related to heat.

18. The sensor jig according to claim 14, wherein the sensors are arranged to collect data related to sound frequency.

19. The sensor jig according to claim 14, wherein the sensors are arranged to collect data related to vibration.

20. The sensor jig according to claim 14, wherein the sensors are arranged to collect data related to power consumption of the vehicle.

21. The sensor jig according to claim 14, wherein the sensors are arranged to collect data related to acceleration or deceleration of the vehicle.

22. The sensor jig according to claim 14, wherein the sensors are arranged to collect data related to torque of a vehicle lifting mechanism.

23. A method for detecting or predicting a malfunction in an automated vehicle operating in an automated storage and retrieval system, the method comprising the steps of:
establishing for a vehicle a baseline set of normal values for various vehicle parameters,
establishing historical maintenance data and/or experimental data for the vehicle, or for a fleet of vehicle of similar model and design, the historical maintenance data and/or experimental data comprising correlations between observable vehicle parameters and the occurrence of malfunctions of a vehicle,
attaching a sensor jig as recited by claim 14 to the vehicle,
using the sensors of the sensor jig to collect data regarding vehicle parameters while the vehicle is in normal operation in the automated storage and retrieval system,
comparing the data collected by the sensors with the baseline values and/or the historical maintenance and/or experimental data,
based on the comparison, making a prediction of a vehicle malfunction.

24. The method according to claim 23, comprising the step of inputting the baseline values, the historical maintenance and/or experimental data, and the data collected by the sensors into an artificial intelligence program, artificial neural network or machine learning algorithm, collectively or alternatively referred to an “AI”, generating an output from the AI, the output comprising the prediction of a malfunction of a vehicle.

25. The method according to claim 23, where the prediction of a malfunction is based upon a detected vehicle parameter outside the baseline range, that also correlates to a historical or experimental value shown to precede a malfunction.

26. The method according to claim 25, further comprising the step of observing or inspecting a vehicle for which a prediction has been made, and inputting a results of the observation or inspection into the AI for the purpose of refining a predictive accuracy of the Al.
